(19) United States
(12) Patent Application Publication
(10) Pub. No.: US 2006/0154024 A1
(43) Pub. Date: Jul. 13, 2006

(54) Playing area module comprising several elastically deformable panels maintined in a curved configuration, and corresponding panel

(76) Inventors: Frederic Saunier, Vert Saint Denis (FR); Romain Guerif, Cesson (FR); Herve Degauchy, Laigneville (FR)

Correspondence Address: EGBERT LAW OFFICES, 412 MAIN STREET, 7TH FLOOR, HOUSTON, TX, 77002, US

(21) Appl. No.: 10/535,717

(22) PCT Filed: Nov. 22, 2002
(86) PCT No.: PCT/FR02/04022

§ 371 Date: Oct. 11, 2005

(51) Int. Cl. B32B 3/10

(52) U.S. Cl. 428/131; 428/99; 428/58

(57) ABSTRACT

The invention concerns a module designed to equip a playing area, characterized in that it comprises at least two panels (1) having substantially the shape of a parallelogram, said panels (1) being made of an elastically deformable material allowing them to shift from a configuration wherein said panels (1) define a plane to a configuration wherein they have a curved shape, and inversely, and in that said panels (1) have, proximate each of the ends of at least one of the edges, at least two orifices: at least one so-called assembling orifice (16), enabling installation of removable fixing means for assembling together said panels (1) and for maintaining them in said configuration wherein said panels have a curved surface; at least one so-called ground-fixing orifice (15), for fixing means for maintaining said module on the ground.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention concerns the field of sports and leisure. More specifically, the invention concerns facilities intended for assembling playing areas.

The playing areas to which the present invention applies are particularly, but not exclusively, intended for activities during which participants must be hidden, protected, masked, totally or partially, to avoid projectiles launched by opponents.

These sports or leisure activities namely include:

paintball, in which the projectiles launched are paint pellets;

softair, in which the projectiles launched are hard plastic pellets or paint pellets similar to those used for paintball, but of a smaller diameter;

laser gun games, in which the players have to protect themselves from beams of particles (wave-length photons that vary from visible to infrared), projected by their opponents;

games involving water pistols;

games with throwers launching foam rubber balls, foam rubber arrows or foam rubber darts.

### BACKGROUND OF THE INVENTION

Currently, there is no simple and satisfying solution to artificially compose this type of playing area. The existing solutions are:

the use of natural elements such as trees, rocks, hillocks, of which the main inconveniences are lack of safety, standardization, and obviously, modularity;

the use of permanent artificial structures such as pallets, drums, tyres, wooden panels, tubes and PVC or concrete worksite pipes of large diameters, of which the main inconveniences are a lack of aesthetic quality, safety, the diversity of shapes and the complexity of maintenance tasks.

Moreover, modification of the playing area requires substantial means.

Also known are dismountable artificial structures such as inflatable elements, self-contained or not, or even elements filled with water.

The main inconveniences are;

the necessity for polluting sources of energy for filling or maintaining a certain amount of internal pressure (for inflatable structures);

tricky maintenance;

the fragility of the materials used;

the necessity for costly peripheral structures;

storage and wintering difficulties;

the limited number of shape combinations;

difficult customization;

the lack of practicality during use on hard ground (lack of stability due to rounded bases);

the potential dangerousness of the rebounding aspect;

a complicated and costly industrial process.

Furthermore, such elements cannot be installed in all types of surrounding, particularly if the playground has natural obstacles such as trees, due to their large structure and bulk.

The invention is namely purposed to ameliorate the inconveniences manifested with the prior elements of the art.

More specifically, the invention is purposed to provide a modular playing area structure that can be mounted and dismounted quickly and easily.

The invention is also purposed to provide such a modular playing area structure that contributes to the safety of the participants and of any spectators.

The invention is also purposed to provide such a modular playing area structure that is aesthetic and that, being easily reproducible, affords unlimited creation possibilities, with decoration and/or customization.

The invention is further purposed to provide such a modular playing area structure that offers satisfactory and durable robustness.

Moreover, the invention is purposed to provide such a modular playing area structure that requires simple maintenance.

Furthermore, the invention is purposed to provide such a modular playing area structure that integrates and respects the natural playing area surroundings.

In addition, the invention is purposed to provide such a modular playing area structure that can be stored in small volumes.

Also, the invention is purposed to provide such a modular playing area structure that can be manufactured easily at a low cost.

Further still, the invention is purposed to provide such a modular playing area structure that offers new possibilities for the activities such as those previously mentioned.

### BRIEF SUMMARY OF THE INVENTION

These purposes as well as other purposes that will later become apparent are achieved on account of the invention of which the purpose is a module intended to equip a playing area, characterized in that it comprises at least two panels that are substantially of the shape of a parallelogram, said panels being made of an elastically deformable material allowing them to shift from a configuration in which said panels define a plane to a configuration wherein they have a curved surface, and inversely, and in that said panels have, proximate to each of the ends of at least one of their edges, at least two orifices:

at least one so-called assembling orifice, allowing installation of removable fixing means for assembling together said panels and for maintaining them in said configuration wherein said panels have a curved surface;

at least one so-called ground-fixing orifice, for positioning fixing means of said panels on ground-fixing means of said module.

A playing area is thus constituted of a certain number of base unit-forming modules, themselves being constituted of an assembly of a certain number of panels, non-specialized personnel being able to mount said modules quickly without requiring specific tools.

A modular structure is thus obtained, in the sense that panels that are identical or distinct (on account of their dimensions, their shapes) may be assembled in variable quantities, in a simple and quick manner, to obtain base modules (themselves being united according to the same method), themselves being of varied shapes, according to requirements and/or the inspiration of the person mounting them.

It is hence easy to create new modules, to record their structural plans and to reproduce them as required. Such a structure allows to modify a playground by changing the shape of the modules completely as opposed to simply moving the same modules.

Furthermore, once the modules are dismounted, the plane configuration (in which the panels remain naturally when there is no stress exerted on them) of the panels allows for simple and efficient storage, with minimum bulk. With paintball for example, a playground comprises twenty-five elements, corresponding to a volume of less than half of one cubic meter during storage.

Moreover, the absence of the need for a polluting source of energy affords the possibility to install a playing area according to the invention, regardless of the area in which it is installed. In addition, the use of recyclable materials contributes to the respect of the environment.

According to an advantageous solution, said orifices are distributed on said panels such that said panels have at least one axis of symmetry.

This characteristic helps to simplify the mounting of the modules insofar as the panels may be positioned indifferently with regard to another panel for the purpose of their assembly.

Advantageously, said panels have three ground-fixing orifices proximate to each of their corners.

Preferentially, said panels also have at least two assembling orifices provided at mid-position between two corners of said panels.

The possibilities of assembling the panels together according to various orientations with regard to one another are thus multiplied. Also, the solidity of the assembly may be reinforced by attaching fixing means to each of the assembling orifices.

According to an advantageous solution, said removable fixing means have at least one of the means belonging to the following group:

bolt/nut;

elastically deformable hook;

snap-on means.

Such fixing means are widespread and are commonly used, consequently contributing to the rapidity, the simplicity and the efficiency of the mounting procedure.

Preferentially, said ground-fixing means have at least one of the means belonging to the following group:

at least one support cooperating with a counterweight;

at least one hook intended to penetrate the ground at least partially.

Such means are easily set up and ensure effective stability and retention of the modules on the ground.

According to another characteristic, said module includes at least one target-forming element comprising at least two orifices intended to be traversed by said fixing means, said at least two orifices allowing to vary the position of said target on said module.

In this case, said one or several targets are intercalated between two of said panels.

Training modules are thus obtained, with which a player can practice without an opponent. The level of difficulty may be adapted by varying the part of the target projecting from the module.

These targets are mounted onto the modules during assembly of the latter, using the assembling means provided for the panels. In other words, target installation does not require any fixing parts in addition to those used for a module without a target.

Preferentially, said module has a section matching at least one of the shapes belonging to the following group:

circle;

triangle;

square;

rectangle;

pentagon;

hexagon

Hence, the hollow shape of the modules in combination with the mounting system can allow to mount the modules around a tree, thereby forestalling the obligation to cut down the latter. Moreover, the thin thickness of the plates as well as its hollow shape allow light and water to pass and thus avoid damaging the turfed surfaces in the case of an event held over several days.

According to a preferred solution, said panels are made of polypropylene copolymer.

More specifically, the material used is a heterophasic polypropylene copolymer with added rubber and stabilizer, of which the trade name is “cartonplast”.

Such a material allows for outdoor storage without risk of damage caused by climatic conditions.

In a general manner, and without departing from the scope of the invention, the material of the panels can be any plastic material with the following properties:

being soft and non-brittle enough to allow for soft impacts, in the event of contact with a player.

being non-rebounding for solid projectiles so as not to risk projecting said projectiles out of the play area boundaries.

Such properties indeed guarantee the safety of the participants as well as that of any spectators.

The invention further relates to a panel intended to integrate a module such as described previously, characterized in that it is substantially of the shape of a parallelogram, said panel being made of an elastically deformable material allowing it to shift from a configuration in which said panel defines a plane to a configuration wherein said panel has a curved surface, and inversely, said panel having, proximate to each of the ends of at least one of its edges, at least two orifices:

at least one so-called assembling orifice, enabling installation of removable fixing means for assembling together said panel with another panel of the same type, and for maintaining them in said configuration wherein said panels have a curved surface;

at least one so-called ground-fixing orifice, for positioning assembling means of said panel on ground-fixing means of said module.

### BRIEF DESCRIPTION OF THE SEVERAL VIEWS OF THE DRAWINGS

Other features and advantages of the invention will be readily apparent from the following description of a preferential embodiment of the invention, and of its alternatives, given by way of illustrative and non-limitative examples, and the accompanying drawings among which:

FIG. 1 is a view of a panel intended to integrate a module according to the invention;

FIGS. 2a and 2b respectively illustrate top and perspective views of a module according to the invention, conformed in such a way that its section substantially constitutes a triangle;

FIGS. 3a and 3b respectively illustrate top and perspective views of a module according to the invention, conformed in such a way that its section substantially constitutes a circle;

FIG. 4 is a sectional view of panels of a module, assembled using fixing means according to a first embodiment;

FIGS. 5a and 5b illustrate views of panels of a module, assembled using fixing means according to a second embodiment;

FIG. 6 is a view of ground-fixing means of a module according to the invention;

FIG. 7 is a top view of a module to which supports for ground-fixing means are added;

FIG. 8 is a view of a module according to the invention, fixed to the ground according to a first embodiment;

FIG. 9 is a view of a module according to the invention, fixed to the ground according to a second embodiment;

FIGS. 10, 11, 12 and 13 are top perspective views of a module according to the invention, comprising three, four, five and six panels respectively,

FIGS. 14 to 17 are top perspective views of modules of the invention, according to alternative embodiments;

FIG. 18 is a perspective view of a set of modules according to the invention, forming a playing area.

### DETAILED DESCRIPTION OF THE INVENTION

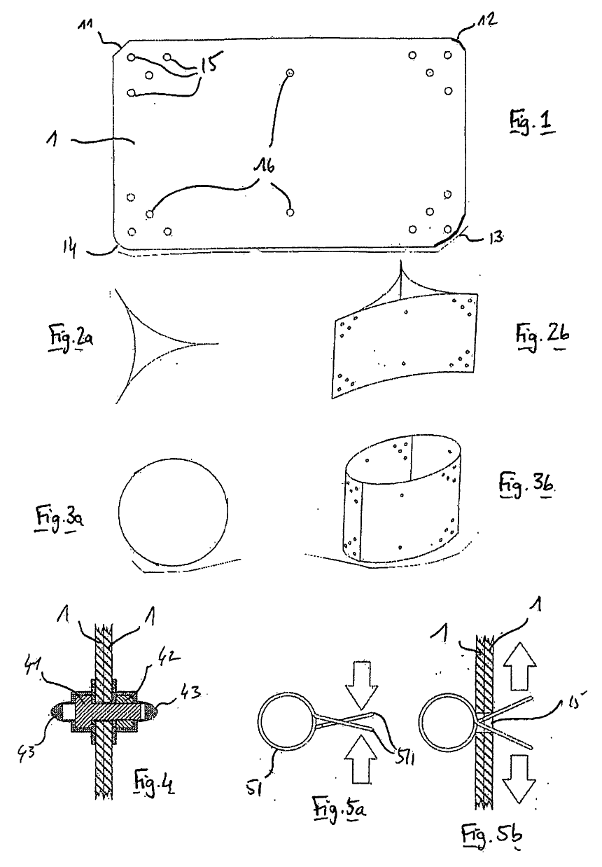

FIG. 1 illustrates a panel intended to be assembled with other modules of the same type to form a module according to the invention.

Such a panel has a substantially square or rectangular shape and may, by way of example, have the following dimensions:

650 mm×1100 mm;

1100 mm×1100 mm;

1550 mm×1100 mm;

2000 mm×1100 mm;

2450 mm×1100 mm.

The thickness of these panels can vary between 0.2 mm and 50 mm depending on the physical properties of the plastic material used.

Preferentially, the panels are made of heterophasic polypropylene copolymer with added rubber and stabilizer, of which the trade name is “cartonplast”.

Such a material is elastically deformable and permits the panel to shift from a storage configuration in which the panel is flat, to an operational configuration in which the panel is curved.

It is noted that the corners of the panel may be formed in several ways (grouped in one same Figure here): corner split in single manner 11, multiple manner 12 and 13 or with a curve as such 14, thus avoiding projecting angles likely to be a risk for the players.

The panels can thus be curved and maintained curved using fixing means elucidated in more detail hereinafter, such as to form a concave shape (as is the case in the module illustrated in FIGS. 2a and 2b, according to which the module shows a section substantially constituting a triangle), or a convex shape (as is the case in the module illustrated in FIGS. 3a and 3b, according to which the module has a substantially circular section), a module, of course, being able to have a combination of concave and convex shapes.

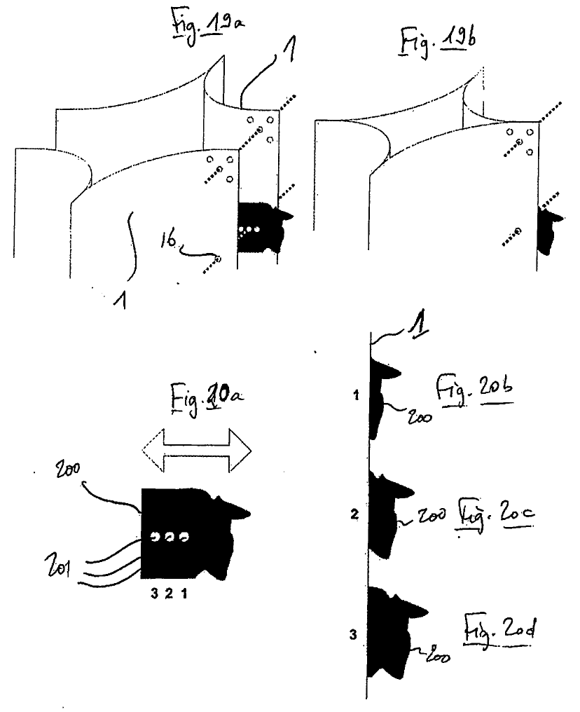

A very wide variety of modules can thus be obtained combining basic shapes such as those illustrated in FIGS. 3a and 10 to 13, themselves being variable according to the number of panels and the dimensions of the latter. From the basic shapes, more elaborate modules can be mounted, such as those illustrated in FIGS. 14 to 17, such modules then being positioned as required on a playground to constitute a playing area, such as that illustrated in FIG. 18.

To enable assembly of the panels, the latter have, according to the embodiment illustrated in FIG. 1, a series of assembling orifices 16 (of which the number and locations can vary as required, namely according to the shape and dimensions of the panels), provided at each corner of the panel.

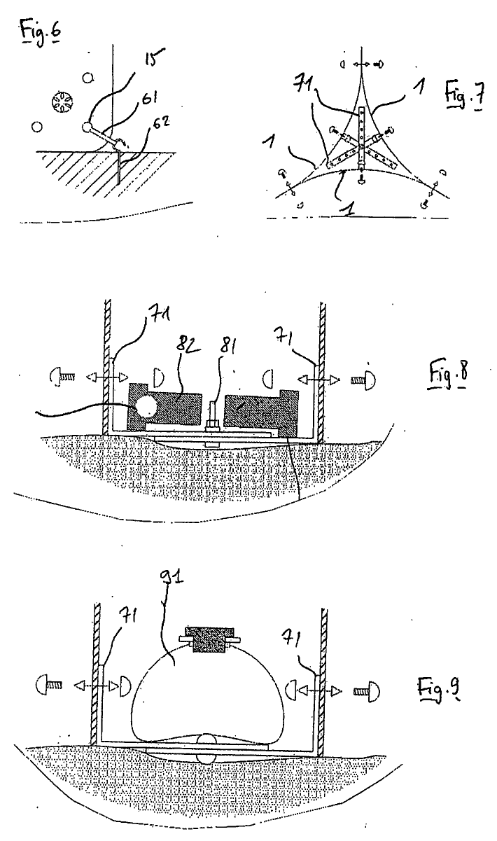

Such orifices enable the introduction and installation of the fixing means, such as those illustrated in FIG. 4 according to which they comprise a plug 41 and a nut 42, both masked by covers 43.

According to another embodiment illustrated in FIGS. 5a and 5b, the fixing means comprise an elastically deformable hook 51 of which the tabs 511 are closely spaced (FIG. 5a) to be introduced into the assembling orifices 15 of the panels, these tabs being released to their diverged position (FIG. 5b) thus maintaining the two panels against one another.

For the purpose of fixing the modules to the ground, the panels also have orifices 15.

According to an embodiment illustrated in FIG. 6, corresponding to a type of game (paintball for example), whereby the modules are installed on loose ground such as turfed ground, ground fixing is obtained using straps 61, whether elastic or not, passed through orifices 15 and attached to the ground by hooked pins 62 otherwise known as pegs.

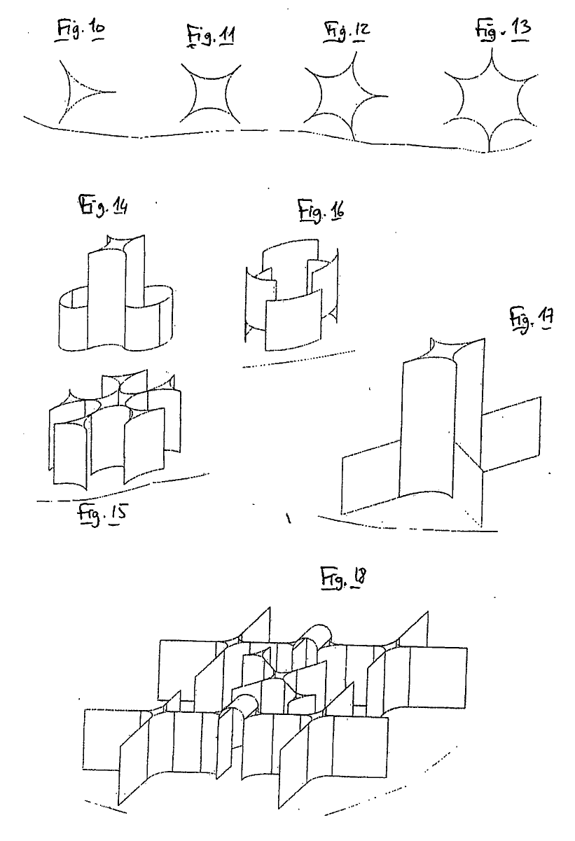

For a type of game played barefoot and/or on ground that does not afford satisfactory positioning of the hooked pins 62 (ground too hard (concrete, tarmac . . . ) or too brittle (snow, sand . . . )), ground-fixing is realized by the positioning of a counterweight (weight or tank of water, sand, gravel . . . ) concealed in the modules, such as illustrated in FIGS. 8 and 9.

These counterweights are positioned using supports 71 attached to the panels 1 (FIG. 7), these supports substantially being of the shape of a bracket (such as clearly demonstrated in FIGS. 8 and 9) and being linked between themselves within the module.

According to the embodiment illustrated in FIG. 8, a pin 81 projects from the base of the supports 71, a counterweight in the shape of a cast iron disk 82 pierced through the centre being in a centred position in relation to said pin 81.

According to the embodiment illustrated in FIG. 9, the counterweight comprises a tank 91 filled with water, sand or gravel and rests on the base of the supports 71.

FIG. 20a illustrates a target 200 intended to be added to a module according to the invention.

The shape of the target as shown on the right-hand side of FIG. 20a corresponds to a silhouette effect of a head dressed in a safety helmet. Of course, the shapes and dimensions of this target can be modified according to other possible embodiments.

According to the present embodiment, the target 200 has three position-adjusting orifices 201, the target 200 being positioned by aligning one of said orifices 201 with the assembling orifices 16 of the panels 1 (FIG. 19a), target 200 being intercalated between these panels 1 such that only the target part as it projects from the panels 1 (FIG. 19b).

It is understood that, according to the orifice 201 used, the surface of the target projecting from the panels can be varied (as illustrated in FIGS. 20b, 20c and 20d), to increase or lower the level of difficulty.

Further improvements or alternatives of the achievement are of course possible.

For example, coloured panels can be used to create more attractive playgrounds. Several types of decoration and customisation are possible:
silkscreen printing directly on the panels, to obtain a permanent and indelible design;
the sandwiching of a poster between one panel of the module and another panel of the same type, but transparent and of thinner thickness; this solution affords occasional display whilst protecting the poster;

overlaying on a module panel an encapsulated poster with the same characteristics including the same drillings; this type of solution offers the possibility to create reusable decorative themes, possibly advertising themes.

Furthermore, the use of translucent plates that can be lit up from the inner part of the module offer another possibility to brighten up playgrounds.

Moreover, a projector or neon lighting system can be provided combined with the use of translucent panels. For sports activities, possible improvements also include electronics by the installation of scoreboard sound signals for alerting scores or playing time.

1. A module intended to equip a playing area, comprising:
at least two panels substantially of a shape of a parallelogram, said two panels being comprised of an elastically deformable material allowing to shift from a configuration in which said two panels define a plane to a configuration wherein said two panels have a curved surface, and inversely, said two panels having, proximate to each of the ends, of at least one of the edges, at least two orifices;
at least one assembling orifice, enabling the installation of a removable fixing means for assembling together said two panels and maintaining said two panels in said configuration wherein said two panels have a curved surface;
at least one ground-fixing orifice, enabling installation of assembling means of said two panels with a ground-fixing means of said module.

2. The module according to claim 1, wherein said orifices are distributed across said two panels such that said two panels have at least one axis of symmetry.

3. Module according to either of claim 1, wherein said two panels have three ground-fixing orifices proximate to each of corner thereof.

4. The module according to claim 1, wherein said two panels further comprise at least two assembling orifices provided at a mid-position between two corners of said two panels.

5. The module according to claim 1, wherein said removable fixing means have at least one of the means belonging to the following group:
bolt (41)/nut (42);
elastically deformable hook (51);
snap-on means.

6. Module according to claim 1, wherein said ground-fixing means have at least one of the means belonging to the following group:
at least one support (71) cooperating with a counterweight;
at least one hook (62) intended to penetrate the ground at least partially.

7. Module according to claim 1, further comprising:
at least one target-forming element comprising at least two orifices to be traversed said fixing means, said at least two orifices enabling variation of the position of said target on said module.

8. Module according to claim 7, wherein said one or several targets are intercalated between two of said panels.

9. Module according to claim 1, wherein said module has a section matching at least one of the shapes belonging to the following group:
circle;
triangle;
square;
rectangle;
pentagon;
hexagon.

10. Module according to claim 1, wherein said two panels are comprised of polypropylene copolymer.

11. Panel intended to integrate a module according to claim 1, being substantially of the shape of a parallelogram, being comprised of an elastically deformable material allowing shift from a configuration in which said panel defines a plane to a configuration in which said panel has a curved surface, and inversely, said panel having, proximate to each of the ends of at least one of its edges, at least two orifices:
at least one so-called assembling orifice, for installation of removable fixing means for assembling together said panel with another panel of the same type, and for maintaining them in said configuration wherein said panels have a curved surface;
at least one so-called ground-fixing orifice, for positioning assembling means of said panel with ground-fixing means of said module.
